(19) United States
(12) Patent Application Publication
(10) Pub. No.: US 2004/0152512 A1
(43) Pub. Date: Aug. 5, 2004

(54) Video game with customizable character appearance

(76) Inventors: David J. Collodi, Taylorville, IL (US); William F. Prendergast, LaGrange, IL (US)

Correspondence Address: WILLIAM F. PRENDERGAST, BRINKS HOFER GILSON & LIONE, P.O. BOX 10395, CHICAGO, IL, 60610, US

(21) Appl. No.: 10/360,509

(22) Filed: Feb. 5, 2003

(51) Int. Cl. A63F 13/00

(52) U.S. Cl. 463/30

(57) ABSTRACT

A video game system operable to create a customized 3-D game character in a game space is disclosed. The video game system includes a converter and a game device. The converter is operable to convert an image of an individual into a file having three-dimensional information representing a physical likeness of the individual. The game device includes an input port and a processor. The input port is operable to receive the file regarding the physical likeness of the individual. The processor is operable to run a video game program for a game. The processor is also adapted to create the customized 3-D game character with the information from the file and generate a display signal including information regarding the customized 3-D game character whereby the customized 3-D game character resembles the individual shown in the image.

### FIELD OF THE INVENTION

The present invention relates generally to the field of video games. More specifically, the present invention relates to a video game capable of producing a customized character created to resemble the appearance of a selected figure/person, such as the game player.

### BACKGROUND OF THE INVENTION

Video games are a very popular form of entertainment and many different types of video games exist. These video game usually involve animated characters that are manipulated through a video input or control device. In many of these games, a predefined character is operated by a user to engage in the animated activity of the game. Many of these video games use a preselected game character having a preselected appearance. There are also games where a player can select the game character from a list of predefined game characters. For example, in many sports games, the user may select the game character, e.g., football player or team, from a list of predefined game characters or teams. It is also understood that games have been provided wherein a game character may be created by the selection of items from a predefined list. However, there has previously been no capability for the user to create a completely customized three-dimensional (3-D) character from a two-dimensional source (2-D).

Therefore, there exists a need for a video game that allows a player to customize the appearance of a game character so that it resembles a selected figure/person, such as the game player.

### SUMMARY OF THE INVENTION

The present invention is directed to a video game with a customizable game character appearance.

According to first aspect of the invention, a video game system operable to create a customized game character in a game space is provided. The video game system includes a converter and a game device. The converter is operable to convert an image of an individual into a file having 3-D information representing a physical likeness of the individual. The game device includes an input port and a processor. The input port is operable to receive the file regarding the physical likeness of the individual. The processor is operable to run a video game program for a game. The processor is also adapted to create the customized game character with the information from the file. The processor also generates a display signal including information regarding the customized game character whereby the customized game character resembles the individual shown in the image.

According to another aspect of invention, a video game system that creates a game space that includes a first customized game character and a second customized game character is provided. A first file is provided having information regarding an appearance of a first individual created by converting an image of a face of the first individual into 3-D information. A second file is provided having information regarding an appearance of a second individual created by converting an image of a face of the second individual into 3-D information. The system includes a first game device having a first processor. The first processor is adapted to receive the first file regarding the appearance of the first individual, replace the first preexisting game character data and generate a first customized character in the game space. The customized game character resembles the appearance of the first individual. The system includes a second game device having a second processor. The second processor is adapted to receive the second file regarding the appearance of the second individual, replace the second preexisting game character data and generate a second customized character in the game space. The second customized character resembles the appearance of the second individual. A first communications port is connected to the first game device and is adapted to 1) receive the first file and 2) communicate with the processor. A second communications port is connected to the second game device and is adapted to 1) receive the second file and 2) communicate with first processor. The first communications port and the second communications port are operable to communicate over a communications network whereby a game space is created-that includes the first customized character and the second customized character.

According to a further aspect of the invention, a video game system that creates a customized game character in a game space using a file having customized 3-D information representing a physical likeness of an individual is provided. The game device includes an input port and a processor. The input port is operable to receive the file regarding the physical likeness of the individual. The processor is operable to run a video game program for a game. The processor has logic adapted to create the customized game character with the information from the file and generate a display signal including information regarding the customized game character. The customized game character is created to resemble the individual.

The present invention, together with attendant objects and advantages, will be best understood with reference to the detailed description below in connection with the attached drawings.

### BRIEF DESCRIPTION OF THE DRAWINGS

FIG. 1 is a diagram illustrating a video game device in accordance with an embodiment of the present invention;

FIG. 2 is a diagram illustrating a video game system in accordance with an embodiment of the present invention;

FIG. 3 is an illustration of an image of a first individual from a first perspective;

FIG. 4 is an illustration of an image of the first individual from a second perspective;

FIG. 5 is a diagram illustrating one embodiment for the converter that converts an image into a file having 3-D information representing a physical likeness of the individual;

FIG. 6 is an illustration of a generic game character on a display;

FIG. 7 is an illustration of a first customized game character based on the image of the individual from FIGS. 3-4;

FIG. 8 is an illustration of an image of a second individual from a first perspective; and

FIG. 9 is an illustration of the first and the second customized game characters, the second customized game character based on the image of FIG. 8.

### DETAILED DESCRIPTION OF THE PREFERRED EMBODIMENTS

The present invention is a video game system that could be applied to home video systems in one embodiment. However, the present invention is not limited to home video games and could be applied in other known environments where a character is intended to be altered. As used herein, the term “individual” is intended to be interpreted broadly to include both real persons, such as a game player, and other entities or fictional characters. As also used herein, the term “image” is intended to be interpreted broadly to include one or more images and include digital photographs, film photographs and other representations bearing the image of an individual. As further used herein, the term “input port” is intended to be interpreted broadly to include a communications port such a modem or direct connection from an associated image acquisition device.

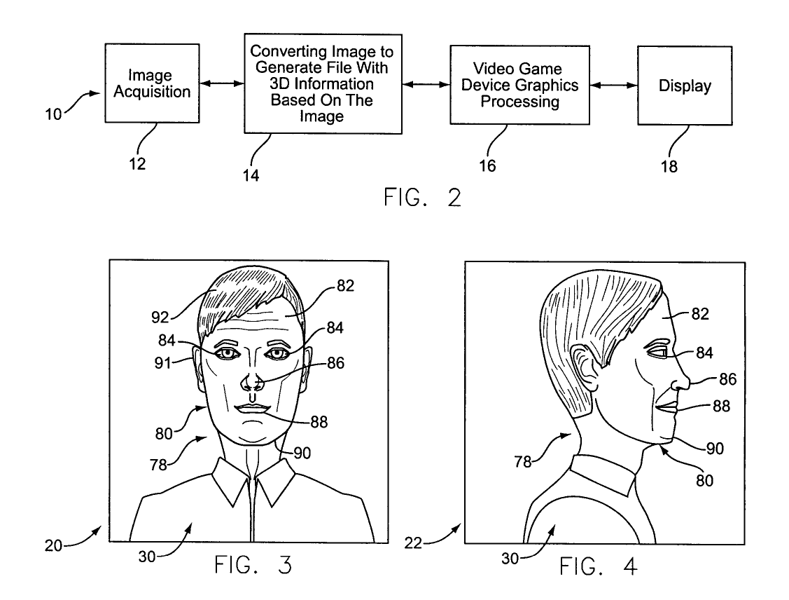

Referring initially to FIG. 2, a video game system 10 according to an embodiment of the present invention is illustrated. The video game system 10 includes a device that may include hardware and/or software that implements the steps of: 1) image acquisition 12, 2) image converting/processing to generate a file 14 having 3-D information based on the 2-D image 12, 3) video game graphics processing 16 and 4) output to a display 18. The first step of image acquisition 12 includes the step of acquiring an image such as the images 20, 22 as shown in FIGS. 3-4. The images 20, 22 are of an individual 30. The second step includes converting/processing the images 20, 22 into 3-D information in a file 14. At least a portion of the images 20, 22 of the individual 30 are converted into the 3-D information (such as 3-D model) in file 14. The third step includes transferring the file 14 with the 3-D information to a video game device 36 for processing. As illustrated in FIG. 7, a game space 38 and a customized 3-D game character 40 are created by the video game device 36 for presentation on a display 18. The customized 3-D game character 40 is generated using the file 14 containing the 3-D information so as to resemble the individual 30. The fourth step involves creating an output signal that is sent to the display 18 for viewing by a player or others. Further description of the aforementioned video game system 10 will be provided herein. It should also be recognized that the above-identified steps may be modified or supplemented and should not be treated as limiting the present invention.

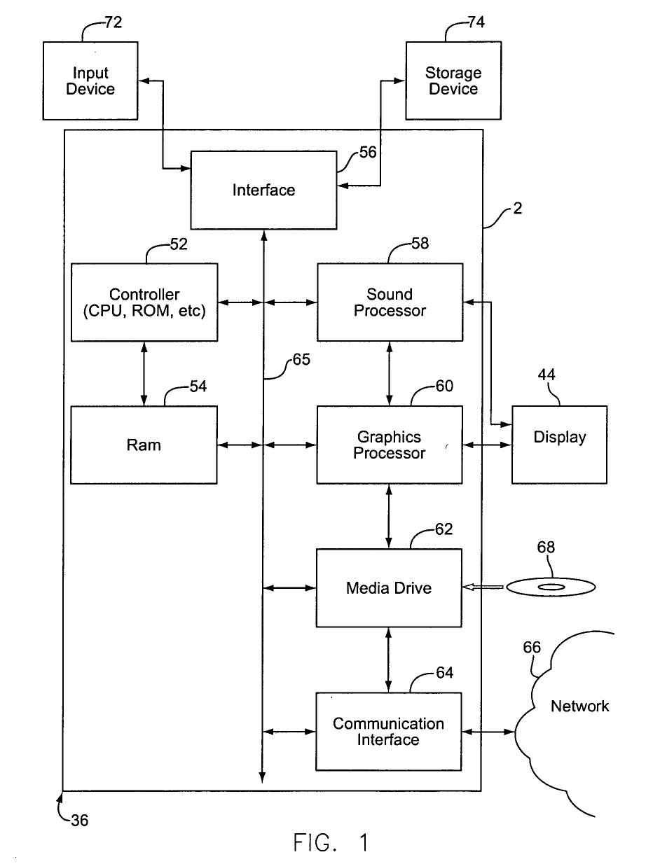

FIG. 1 is a block diagram showing a video game device 36 according to one embodiment of the present invention. It should be recognized that other known constructions for a video game device could be implemented. The video game device 36 includes a controller 52, a RAM (random access memory) 54, an interface 56, a sound processor 58, a graphics processing unit 60, a media drive (such as a CD-ROM or DVD-ROM),62 and a communications interface 64 which are interconnected to each other via a bus 65. The communications interface 64 is connected to an external network 66 such as a local area network or the internet. A removable media (such as a CD or DVD) 68 is loaded into and unloaded from the media drive 62. The controller 52 includes a CPU (central processing unit) and a ROM (read only memory) for storing basic programs such as a boot program and operating system. The controller 52 also operates a program stored in the RAM 54 in order to implement processing for the game. The controller 52 controls the operation of all of the elements of the video game device 36 from the RAM 54 through the communications interface 64. The RAM 54 is used as a main memory of the video game device 36 and stores the program and data necessary for controlling the game progress transferred from the removable media 68. The graphics processor 60 produces a display signal that is shown on a display 44. The display 44 includes a display unit such as a cathode ray tube, plasma display, LCD display or other display operable to show the display signal. The display 44 also includes a speaker that provides for the output of an audible signal based on the sound signal received from the sound processor 58.

The input device 72 is connected to the interface 56. The interface 56 controls the data exchange between the exterior components, e.g., the input device 72 and the interior components, e.g., the controller 52 and the RAM 54. The input device 72 is provided with various direction and control elements such as buttons or a digital/analog joystick. A player operates the control elements to control the progress of the game, such as the start of the game or the movement of a game character. This movement is controlled to provide animation of the customized 3-D game character 40. It is an important aspect of the present invention that the file 14 contain 3-D information such as 3-D model. Accordingly, the customized 3-D game character 40 will appear as any other game character as it moves through the game scene by walking or running. The 3-D output is important for the customized game character 40 to appear realistic. A 3-D game character will have the correct likeness not just from a front view, but from a side profile, or preferably from a profile at any angle. Similarly, the customized game character 40 may be controlled such as by manipulating the character's leg to kick or jump and appear as the original game character would.

A storage device 74 is also connected to the controller 52. The storage device 74 is operable to store the file 14 containing the 3-D information regarding the physical appearance of the individual 30. While the storage device 74 is shown as an external device (such as a memory card or writeable disk), the storage device 74 can also be an internal device such as a fixed disk drive.

In response to a command from the controller 52, the sound processor 58 implements processing for the generation of sound data such as sound effects or background music depending on the progress of the game. The sound processor 58 outputs a sound signal to the display 44, and particularly to the speaker that forms a part of the display 44. The controller 52 also controls the graphics processor 60. The graphics processor 60 implements 3-D processing to produce a display signal according to the progress of the game. The controller 52 further operates the media drive 62 that drives the external media 68 loaded therein so as to transfer the stored program to the RAM 54 via the bus 65. The communications interface 64 is connected to an external network 66 such as the internet via a communications cable. In response to a command from the controller 52, the communications interface 64 implements processing for data receipt/exchange with the external network 66.

The external media 68 stores the program and data useful for controlling the progress of the game. The media 68 is driven by the media drive 62 so that the stored program and data are read out. The program and data read from the media 68 are transferred from the media drive 62 to the RAM 54 via the bus 65. The file 14 containing the 3-D information is initially stored in the RAM 54. However, for future uses, the file 14 may be stored in the storage device 74 and retrieved by the interface 56 when necessary. The display 44 displays a game space based on the display signal received from the graphics processor 60.

The step of image acquisition 12 is best represented in FIGS. 3-4. The first image 20 of the individual 30 is a front view. The first image 20 and any other additional images are acquired using conventional image acquisition devices such as a film camera, digital camera, video camera or other know devices. Also, it should be recognized that the image acquisition device may be separate from the video game device 36 or directly, i.e., integrally connected or wirelessly connected to the video game device 36. The first image 20 illustrates the head 78 including the facial features 80. The facial features 80 include the forehead structure 82, eye structure 84, nose structure 86, mouth structure 88, and cheek structure 90. Ears 91 are also illustrated. The hair 92 including facial hair are further illustrated. The images 20, 22 also illustrate the color and appearance of the facial features 80, i.e., skin tone and the hair 92. FIG. 4 is a second image 22 from a side view that further illustrates the head 78 and facial features 80 from another perspective. While FIGS. 3-4 are intended to represent an embodiment where the images 20, 22 are presented on digital photographs, the images 20, 22 of the individual may be created from other photographic media or other representations known to those of ordinary skill in the art such as a sketch. A preferred embodiment uses multiple images to increase the accuracy of the generated 3-D information. Alternate embodiments are operable to generate 3-D information based on a single image.

The second step of the present invention includes converting the images 20, 22 into a file 14-having 3-D information, such as a 3-D model. The 3-D information represents the physical likeness of the individual 30. In one embodiment, the 3-D information is particularly directed to the facial features 80 of the individual 30. However, it should be recognized that more just the facial features of individual could be used to create the 3-D model. Some embodiments send the images 20, 22 to a location remote from the video game device 36 for conversion into a file 14 having the 3-D information. In alternate embodiments, the controller 52 and RAM 54 are operable to convert the images 20, 22 into a file 14 having 3-D information. An image acquisition device, such a digital camera, could be directly connected to video game device 36 and directly input image information thereto.

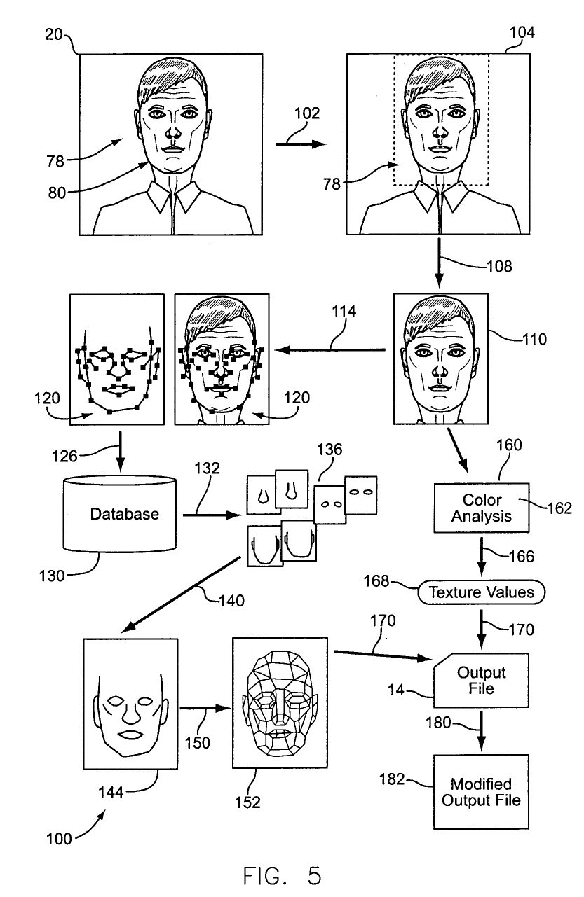

FIG. 5 illustrates one embodiment of an algorithm, implemented by suitable logic in the converter 100. The logic in the converter 100 is operable to convert one or more images 20, 22 into a file 14 having 3-D information. At head location step 102, the converter 100 uses standard image processing techniques to determine the size and location of the head 78 within the image 20 as shown at the image 104. At head cropping step 108, the image 104 is then converted by the converter to a centered image 110 that comprises only the area occupied by the head 78. At feature point step 114, a set of feature points 120, representing information such as the profile, eyes and nose is identified by the converter 100. The feature points 120 identify characteristics of the head 78 and facial feature 80 related to bone structure such as the shape of the profile and size and relative positions of the forehead, eyes, nose, mouth and cheek bones. Image processing techniques exist and are known which are operable to locate and identify feature points based on rapid, localized pixel intensity variations. One embodiment uses known image processing techniques to identify the feature points 120, while alternate embodiments employ other known methods for the identification of the feature points. It will be recognized that the logic used by the converter 100 may be implemented in software, hardware or any suitable combination.

If a plurality of images is used, feature points are likewise identified from each image in a similar manner. At comparison step 126, the feature points 120-from one or more images are compared with feature information stored in a database 130 comprising feature information from a plurality of known facial types where said feature information contains 3-D information. At feature match step 132, a set of feature matches 136 are found which represent data from the database 130 that most closely match the feature points 120 of the centered image 110. At composite feature step 140, the set of feature matches 136 are combined to produce a composite feature set 144. In a preferred embodiment, the composite feature set 144 comprises a weighted average of the set of feature matches 136 wherein each feature match is weighted by its correlation to the original set of identified feature points 120. At 3-D model step 150, 3-D information from the database 130 is used to produce 3-D model data 152 from the composite feature set 144. At color analysis step 160, color analysis 162 is performed to determine approximate hair, skin and eye color. In a texture value step 166, color samples are taken of known areas, such as eyebrows, eyes, cheeks and forehead, to determine a set of texture values 168 containing color information. At combining step 170, the 3-D model information 152 and texture values 168 are used in the creation of the output file 14. In one embodiment, a modified output step 180, provides for the creation of a modified output file 182 that contains altered data about the facial features 80 so that the customized game character 40 can have a different appearance than in the image 104 such as a different facial expression or hair style.

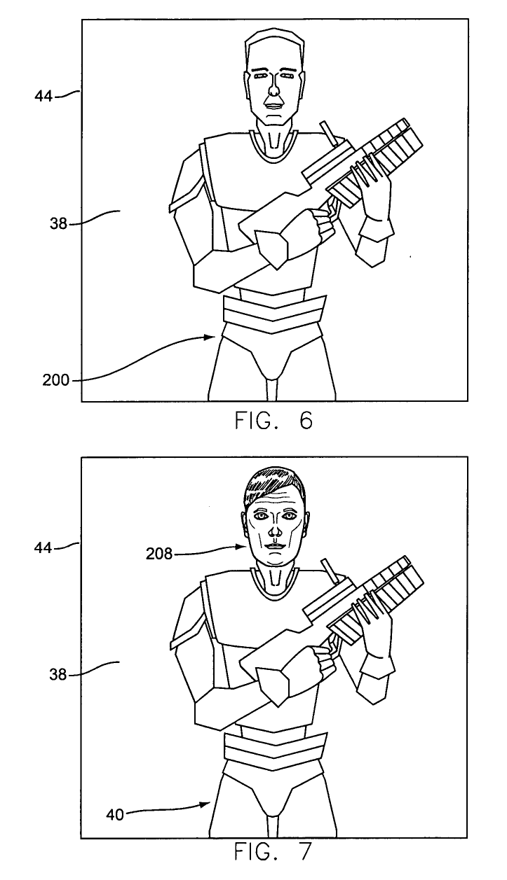

Once generated, the file 14 is transferred to the video game device 36 through an input port. In one embodiment, the file 14 is transferred to a video game device 36 through the network 66, such as the Internet, to the communications interface 64. In alternate embodiments, the file 14 is directly input to the game player through the media drive 62 or another external drive. The file 14 is initially transferred to the RAM 54 where it replaces preexisting game character data. In particular, in one embodiment, the file 14 includes 3-D information on the facial features 80 of the individual 30. The file 14 replaces any previous relevant information. It also should be recognized that the game character may have no preexisting facial features and the file 14 would provide the initial facial features for the customized 3-D game character 40. The video game device 36 then operates in essentially the same manner as a conventional video game device. Accordingly, rather than generate a conventional game character 200 (FIG. 6), the customized 3-D game character 40 is generated on the display 44. The customized 3-D game character 40 is thereby generated to resemble the individual 30 as shown in the images 20, 22. In the illustrated embodiment, the customized 3-D game character 40 includes facial features 208 that resemble the facial features 80 of the individual 30.

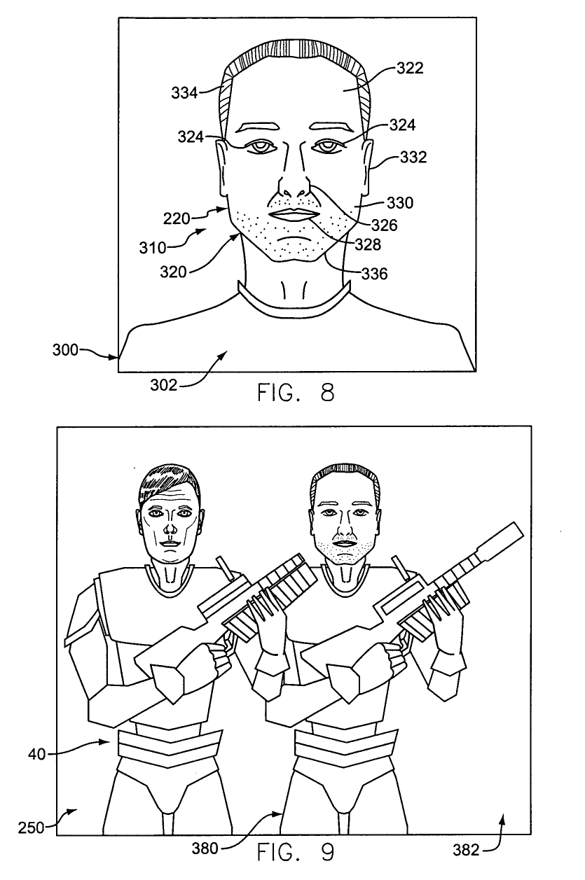

FIG. 8 illustrates a third image 300 of another or second individual 302. The third image 300 is a front view. However, it should be recognized that additional images from additional perspectives may be used in the second step to generate the 3-D information about the second individual 302. Again, the third image 300 illustrates the head 310 and facial features 320. The facial features 320 include the forehead structure 322, eye structure 324, nose structure 326, mouth structure 328, and cheek structure 330. Ears 332 are also illustrated. The hair 334 including facial hair 336 are further illustrated. It should be recognized that while the character may be an individual as described herein, it may also be things other than human beings. For example, if the game contained a dog (or other creature) as a character, the user may use his/her dog as an image that the game will use. Alternatively, the user may decide to input a cartoon character or an image of one of the players in the game. Other possibilities for the game character will be apparent to those of ordinary skill in the art. The important feature here of the present invention is that the player selects a character to be a part of a video game from a source outside of the video game. Through the above-described steps of image acquisition, image conversion and video game processing, the player creates a unique 3-D character that is a part of a video game.

Using essentially the same process as described above, a file is created including 3-D information based on the third image 300 of the second individual 302. A second video game device, in one embodiment, is used to generate a second customized 3-D game character 380 as shown in the display 382 illustrated in FIG. 9. In one embodiment, it is intended that game players using online games be able to generate customized 3-D game characters 40, 380 and play a game online using the communication interface 64 of the video game device 36 to communicate over the network 66. Accordingly, two or more game players could play online using two customized 3-D game characters 40, 380 or more which actually resemble the game players or other selected individual(s).

It should be recognized that it is an important part of the present invention that 3-D information, such as 3-D model, regarding the individual be created from a 2-D source. The 3-D information is intended to allow the customized 3-D game character to appear and be capable of movement just like any other controllable 3-D game character. Accordingly, the customized 3-D character can be moved and/or controlled to conduct any action that was intended to be provided for by the game while also having a 3-D appearance like any other game character. The use of a 2-D input image that is converted to a 3-D model or profile makes the present invention readily applicable to wide array of applications. It should also be recognized that present invention has application broader the video games. The present invention could also be used to replace any animated character in other applications such as animated films available on media such as DVD.

The embodiments described above and shown herein are illustrative and not restrictive. The scope of the invention is indicated by the claims rather than by the foregoing description and attached drawings. The invention may be embodied in other specific forms without departing from the spirit of the invention. For example, the structure of the video game device or the process for conversion of the image may be modified and yet operate in the same general manner. Accordingly, these and any other changes which come within the scope of the claims are intended to be embraced herein.

We claim:

1. A video game system that creates a first customized 3-D game character in a game space, the video game system comprising:
a converter operable to convert a 2-D image of an individual into a file having 3-D information representing a physical likeness of the individual;
a game device including an input port and a processor, the input port operable to receive the file, and the processor operable to run a video game program for a game, the processor having logic adapted to create the first customized 3-D game character with the information from the file and generate a display signal including information regarding the first customized 3-D game character whereby the first customized 3-D game character resembles the individual shown in the image.

2. The video game system of claim 1 wherein the individual is a person.

3. The video game system of claim 1 wherein the individual is a fictional character.

4. The video game system of claim 1 wherein the input port includes a modem.

5. The video game system of claim 1 wherein the information representing the physical likeness represents only 3-D facial features of the individual.

6. The video game system of claim 1 wherein the image is from a photograph.

7. The video game system of claim 6 wherein the image is from a digital photograph.

8. The video game system of claim 7 wherein more than one image of the individual is used by the converter.

9. The video game system of claim 7 wherein the converter provides for the 3-D information to be customized.

10. The video game system of claim 9 wherein the converter provides for the alteration of at least one element selected from a group consisting of hair color, hair appearance, eyes, facial structure, and facial skin tones.

11. The video game system of claim 1 further comprising a second customized 3-D game character based a second image of a second individual, the first customized 3-D game character and the second customized 3-D game character are operable in a game space.

12. The video game system of claim 11 wherein the first and the second customized 3-D game characters are operable from remote locations.

13. The video game system of claim 12 wherein the first and the second customized 3-D game characters operate in the game space wherein a first player and a second player are interconnected via the internet.

14. The video game system of claim 13 wherein the converter is remote from the game device.

15. The video game system of claim 14 wherein the converter can communicate to the processor over a communications network.

16. A video game system that creates a game space that includes a first customized 3-D game character and a second customized 3-D game character, said video game system comprising:
a first file having information regarding an appearance of a first individual created by converting an image of a face of the first individual into 3-D information and a second file having information regarding an appearance of a second individual created by converting an image of a face of the second individual into 3-D information;
a first game device having a first processor that is adapted to receive the first file regarding the appearance of the first individual, replace the first preexisting game character data and generate a first customized 3-D game character in the game space, the first customized 3-D game character resembling the appearance of the first individual and a second game device having a second processor that is adapted to receive the second file regarding the appearance of the second individual, replace the second preexisting game character data and generate a second customized 3-D game character in the game space, the second customized 3-D game character resembling the appearance of the second individual;
a first communications port connected to the first game device and adapted to 1) receive the first file and 2) communicate with the processor, and a second communications port connected to the second game device and adapted to 1) receive the second file and 2) communicate with first processor, the first communications port and the second communications port operable to communicate over a communications network whereby a game space is created that includes the first customized 3-D character and the second customized 3-D character.

17. The video game system of claim 16 wherein the individual is a person.

18. The video game system of claim 17 wherein the person is a game player.

19. The video game system of claim 16 wherein the individual is a fictional character.

20. The video game system of claim 16 wherein the first and second communications ports include a modem.

21. The video game system of claim 20 wherein the image is from a digital photograph.

22. The video game system of claim 21 further comprising a converter operable to create the first file and the second file.

23. The video game system of claim 22 wherein the converter provides for the 3-D information to be customized.

24. A video game system that creates a customized 3-D game character in a game space using a file having customized 3-D information representing a physical likeness of an individual, the video game system comprising:
a game device including an input port and a processor, the input port operable to receive the file regarding the physical likeness of the individual, and the processor operable to run a video game program for a game, the processor having logic adapted to create the customized 3-D game character with the information from the file and generate a display signal including information regarding the customized 3-D game character whereby the customized 3-D game character resembles the individual.

25. The video game system of claim 25 wherein the processor has logic adapted to replace preexisting character data.

26. The video game system of claim 25 wherein the individual is a person.

27. The video game system of claim 26 wherein the 3-D information in the file is based on a composite set of feature points on the individual.

28. The video game system of claim 27 wherein the 3-D information in the file includes color information.

29. The video game system of claim 28 wherein the color information includes a hair color of the individual.

30. The video game system of claim 29 wherein the color information includes a skin color.
